(19) United States
(12) Patent Application Publication
(10) Pub. No.: US 2009/0101273 A1
(43) Pub. Date: Apr. 23, 2009

(54) MOVABLE CONTACT UNIT WITH BUMPS AND METHOD OF MANUFACTURING THE SAME

(75) Inventors: Minoru Karaki, Okayama (JP); Nobuhiro Numoto, Okayama (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/255,925

(22) Filed: Oct. 22, 2008

(30) Foreign Application Priority Data
Oct. 23, 2007 (JP) 2007-274976

(51) Int. Cl. B32B 37/02

(52) U.S. Cl. 156/182

(57) ABSTRACT

Disclosed is a method of efficiently bonding bump members of a small cylindrical shape punched out of a highly flexible plastic film without leaving considerable extent of cutting burrs. The method comprises steps of forming bump members 45 by carrying out a half-cut process on first substrate 56 comprising highly flexible first plastic film 51 adhered to first reinforcing film 53 of a material having rigidity higher than first plastic film 51 with adhesive layer 52, removing first plastic film 51 in a manner to leave cut-out bump members 45 on first reinforcing film 53, adhering bump members 45 to second plastic film 61 coated with adhesive 47, and securely bonding thereafter bump members 45 to second plastic film 61 by hardening adhesive 47.

### BACKGROUND OF THE INVENTION

1. Field of the Invention

The present invention relates to a movable contact unit with bumps used for a panel switch and the like device for input control of various electronic apparatuses, and the invention also relates to a method of manufacturing the same.

2. Background Art

With the advancement in recent years of reduction in sizes and weights of various electronic apparatuses, there have been considerable efforts put into development of such panel switches as featuring low profile, capability of yielding good tactile responses to actuations and electrically stable contacts for use as input control means of these apparatuses. A large number of panel switches now available are the type that uses a so-called movable contact unit comprising a plurality of dome-shaped movable contacts formed of conductive metal plates having elasticity, and an insulating plastic sheet retaining the movable contacts individually. In addition, there is also a rise in popularity of such apparatuses as those equipped with lighted control buttons for ease of operation even in the nighttime, and those having luminous sources of LED's are now used widely.

Referring to the accompanying drawings, description is provided hereinafter of a conventional movable contact unit of such type and a panel switch composed of the same.

FIG. 19 is a sectioned view of a panel switch equipped with a conventional movable contact unit disclosed in Japanese Patent Unexamined Publication, No. 2004-193047, and FIG. 20 is an exploded perspective view of the same panel switch.

In FIG. 19 and FIG. 20, base film 1 made of a plastic sheet of polyethylene terephthalate (hereinafter referred to as “PET”) has its underside surface coated with adhesive layer 2 of a predetermined pattern.

A plurality of movable contacts 3 made of thin sheets of electrically conductive metal having flexibility and formed into a circular and upwardly convex dome-like shape are fixed to base film 1 with their upper surfaces individually bonded to adhesive layer 2.

Base film 1 has through-holes 1A perforated in a plurality of locations corresponding to mounting positions of LED's 13, as shown in FIG. 20.

Bump members 5 formed of a plastic sheet of PET into a cylindrical shape of small diameter by a punching process are bonded with adhesive 6 to base film 1 in locations corresponding to center positions of movable contacts 3.

Base film 1 and bump members 5 have adhesion promoting layers 1B and 5A on their respective surfaces to be bonded with adhesive 6, so as to retain bump members 5 in a given bonding condition on the upper surface of base film 1 without allowing bump members 5 to come off in spite of repeated switching operations as will be described later.

For the purpose of making the drawing simple and comprehensible, adhesion promoting layers 1B and 5A are omitted in the exploded perspective view of FIG. 20. In addition, the sectioned view of FIG. 19 is enlarged dimensionally only in one direction along its thickness, and the same enlargement is also applied to each of the subsequent drawings.

Conventional movable contact unit 8 is constructed as discussed above. Conventional movable contact unit 8 of the above structure is bonded onto corresponding wiring board 10 with adhesive layer 2 on base film 1, and used as a panel switch.

Wiring board 10 has a pair of stationary contacts 11 on the upper surface at each of locations corresponding to the positions where movable contacts 3 are disposed. Stationary contacts 11 consist of outer stationary contact 11A of a ring-like shape and center stationary contact 11B at the center of the outer stationary contact 11A. When movable contact unit 8 is in the properly bonded position on wiring board 10, the individual movable contacts 3 are situated in a manner that their lower center surfaces confront respective center stationary contacts 11B with a predetermined space, and their outer rims lie in contact with respective outer stationary contacts 11A. Each movable contact unit 8 assembled as discussed above composes a single unit of push-on type switch.

Wiring board 10 is provided with LED's 13 mounted on predetermined locations so that these LED's 13 are situated within through-holes 1A perforated in base film 1 when movable contact unit 8 is assembled.

The panel switch constructed in the above manner is provided with control buttons made of an optically transparent material, which is placed on top thereof, although not shown in the drawings. When any of the control buttons is pushed, the downwardly moved control button depresses the corresponding one of bump members 5 on movable contact unit 8, and this force is impressed on the center part of the corresponding one of movable contacts 3 through bump member 5. When this depressing force exceeds a predetermined amount, the center part of movable contact 3 deforms into an inverse shape with a tactile response, and the lower center portion of it comes in contact with center stationary contact 11B. This establishes continuity between stationary contacts 11A and 11B via movable contact 3 to turn the switch into an ON state.

When the depressing force is removed, movable contact 3 deforms by itself to restore the original upwardly convex shape and to turn the switch into the OFF state shown in the FIG. 19 while pushing back the control button. The control buttons are illuminated when LED's 13 are lit.

Incidentally, the above structure may require a photo-conductive body in some instances to improve uniformity of the lighting since the control buttons are illuminated by LED's 13 functioning as point light sources. As a remedial measures for this drawback, movable contact units provided with electroluminescent elements (hereinafter referred to as “EL elements”), or surface luminous elements have been put into practical use in the recent years. Referring now to FIG. 21 to FIG. 23, description is provided of movable contact unit 19 equipped with an EL element, which is disclosed in Japanese Patent Unexamined Publication, No. 2001-273831.

As shown in FIG. 21, movable contact unit 19 is provided with various functional layers 17 constituting an EL element, which is formed by repeating printing and baking on the backside of base film 15 formed of an optically transparent PET. The previously discussed adhesive layer 2 is then formed on the lowermost layer, and the upper center surfaces of the aforesaid movable contacts 3 are fixed to adhesive layer 2. Various functional layers 17 of the EL element comprise at least transparent electrode layer 17A, luminescent layer 17B, dielectric layer 17C, back electrode layer 17D and insulation layer 17E, which are stacked in this order from base film 15 side, as shown in FIG. 22.

In addition, separator 20 having an upper surface treated with release lining is pasted to adhesive layer 2, as shown in FIG. 21, in order to prevent movable contacts 3 and adhesive layer 2 from unwanted dust during transportation and storage.

Movable contact unit 19 of the above structure is also bonded onto wiring board 10 having stationary contacts 11 with adhesive layer 2, as shown in FIG. 23, and used as a panel switch in the same manner as discussed previously.

The panel switch is also operated in the similar manner that any of movable contacts 3 is deformed into an inverse shape to perform the switching function with a depressing force impressed upon movable contact 3 through base film 15 and various functional layers 17 of the EL element by way of pushing base film 15 from above. Furthermore, the EL element of movable contact unit 19 produces surface illumination of a predetermined color when an AC voltage of a predetermined value is applied between transparent electrode layer 17A and back electrode layer 17D of the EL element. It can hence illuminate uniformly the control buttons located above.

Both of the above-discussed former movable contact unit 8 and the latter movable contact unit 19 employ films made of PET for base films 1 and 15, and bump members 5 in order to produce them with low costs. Since PET films are materially classified under a category of high stiffness and low elasticity, these properties weaken the active force of movable contacts 3 for making inverse deformation in response to the pushing operation. Therefore, it has been the practice to use films of small thickness in order to avoid decrease in clicking rate and to obtain good tactile responses.

The latter movable contact unit 19 is desirable in view of the lighting uniformity because of the surface illumination. However, the operating responses produced by movable contacts 3 are felt very week even when base film 15 is formed of a thin PET film as thin as 12 μm to 100 μm in the thickness, because this film needs to be overlaid with the EL element, which increases the stiffness. In addition, movable contact unit 19 imposes many restrictions on the apparatus in order to reduce a positional deviation in assembling with the control buttons and to obtain good tactile responses since it is not provided with bump members 5 as used in the former movable contact unit 8.

The present applicant has carried out a series of studies for substituting the material of base film 15 with a flexible material, that is thermoplastic polyurethane (hereinafter referred to as “TPU”) made of a polyurethane resin, as the first attempt to improve these shortcomings. At the same time, this applicant has also made studies for employing bump members made of a flexible material.

Because of the high flexibility of the TPU film, however, there are often cases when the TPU film is put to a punching process to simply cut out bump members of a small cylindrical shape that the film is rather torn off by a cutting blade at the end of the process and this leaves many burrs around the lower edge in the cutting direction. It becomes difficult to ensure mounting of the bump members steadily under such a condition, thereby giving rise to a problem of requiring selection of good bump members in some cases before mounting.

### SUMMARY OF THE INVENTION

The present invention addresses the above problems of the conventional art, and provides a method of manufacturing a movable contact unit with bumps, whereby the method is capable of cutting bump members from a highly flexible plastic film such as a TPU film without leaving significant extent of burrs, and mounting these bump members efficiently to the corresponding movable contact unit to complete the movable contact unit with bumps.

The method of manufacturing the movable contact unit with bumps of the present invention comprises a first step of forming a first work-in-process item by preparing a first substrate comprising a first plastic film having flexibility and a first reinforcing film of higher rigidity than the first plastic film, the first reinforcing film adhered to the underside of the first plastic film with an adhesive layer, and by carrying out a half-cut process on an upper side of the first substrate to cut through the first plastic film and the adhesive layer to form bump members of a given shape, a second step of forming a second work-in-process item by removing an unnecessary portion of the first plastic film in a manner to leave the bump members formed by the half-cut process on the first reinforcing film and to expose the adhesive layer in an area where the portion of the first plastic film is removed, a third step of forming a third work-in-process item by coating an adhesive for bonding the bump members on one of surfaces of a second plastic film having flexibility, a fourth step of forming a fourth work-in-process item by positioning the second work-in-process item with the third work-in-process item in a manner to bond the bump members left on the second work-in-process item to the second plastic film with the adhesive on the third work-in-process item and bonding the second work-in-process item onto the third work-in-process item by using the adhesive layer exposed on the second work-in-process item, and a fifth step of fixing movable contacts to an opposite surface of the second plastic film in locations corresponding to positions where the bump members are bonded, after completing hardening of the adhesive.

According to the structure described above, it becomes possible to ease the process of cutting the bump members from the first plastic film of high flexibility such as a TPU film while reducing cutting burrs around the bump members since the first reinforcing film serves as a support. Furthermore, this method facilitates bonding of the bump members efficiently to the corresponding movable contact unit with the aid of the first reinforcing film as a production supporting material, and helps manufacture movable contact units with bumps continuously and efficiently.

In the method of manufacturing the movable contact unit with bumps of this invention, it is desirable that the third step of forming the third work-in-process item may be modified to include processes of forming a functional layer constituting an electroluminescent element on the second plastic film by using a second substrate comprising a second reinforcing film of a material having higher rigidity than the second plastic film, the second reinforcing film adhered on one of the surfaces of the second plastic film, and coating the surface of the second plastic film with the adhesive for bonding the bump members after removing the second reinforcing film and cleansing the exposed surface.

This method improves the ease of handling the second plastic film as well as consistency of coating the adhesive and the bonding condition by virtue of the additional cleansing process.

### BRIEF DESCRIPTION OF THE DRAWINGS

FIG. 1 is a sectioned view of a movable contact unit with bumps manufactured according to a method of manufacturing the movable contact unit in an exemplary embodiment of the present invention;

FIG. 2 is an exploded perspective view of the same movable contact unit;

FIG. 3 is a first sectioned view illustrating a first step of the method of manufacturing the same;

FIG. 4 is a first plan view illustrating the first step of the same method;

FIG. 5 is a second sectioned view illustrating the first step of the same method;

FIG. 6 is a third sectioned view illustrating the first step of the same method;

FIG. 7 is a second plan view illustrating the first step of the same method;

FIG. 8 is a fourth sectioned view illustrating the first step of the same method;

FIG. 9 is a perspective view illustrating a second step of the same method;

FIG. 10 is a first sectioned view illustrating the second step of the same method;

FIG. 11 is a second sectioned view illustrating the second step of the same method;

FIG. 12 is a first sectioned view illustrating a third step of the same method;

FIG. 13 is a second sectioned view illustrating the third step of the same method;

FIG. 14 is a third sectioned view illustrating the third step of the same method;

FIG. 15 is a first sectioned view illustrating a fourth step of the same method;

FIG. 16 is a second sectioned view illustrating the fourth step of the same method;

FIG. 17 is a first sectioned view illustrating a fifth step of the same method;

FIG. 18 is a second sectioned view illustrating the fifth step of the same method;

FIG. 19 is a sectioned view of a panel switch constructed of a conventional movable contact unit;

FIG. 20 is an exploded perspective view of the same panel switch;

FIG. 21 is a sectioned view of another conventional movable contact unit;

FIG. 22 is an enlarged sectioned view of a prime portion of the same movable contact unit; and

FIG. 23 is a sectioned view of a panel switch constructed of the same movable contact unit.

### DETAILED DESCRIPTION OF THE INVENTION

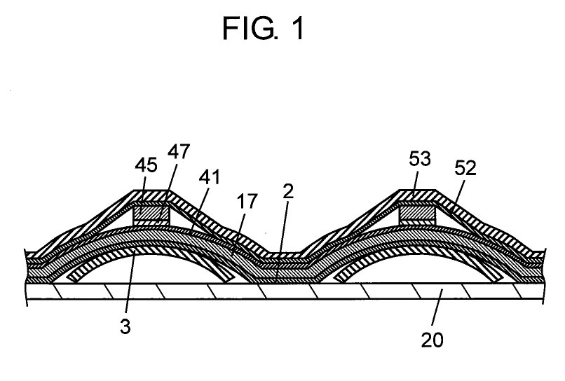

Description is provided hereinafter of an exemplary embodiment of the present invention with reference to FIG. 1 to FIG. 18. Like reference numerals are used to designate like structural components as those described in the background art, and their detailed description will be skipped.

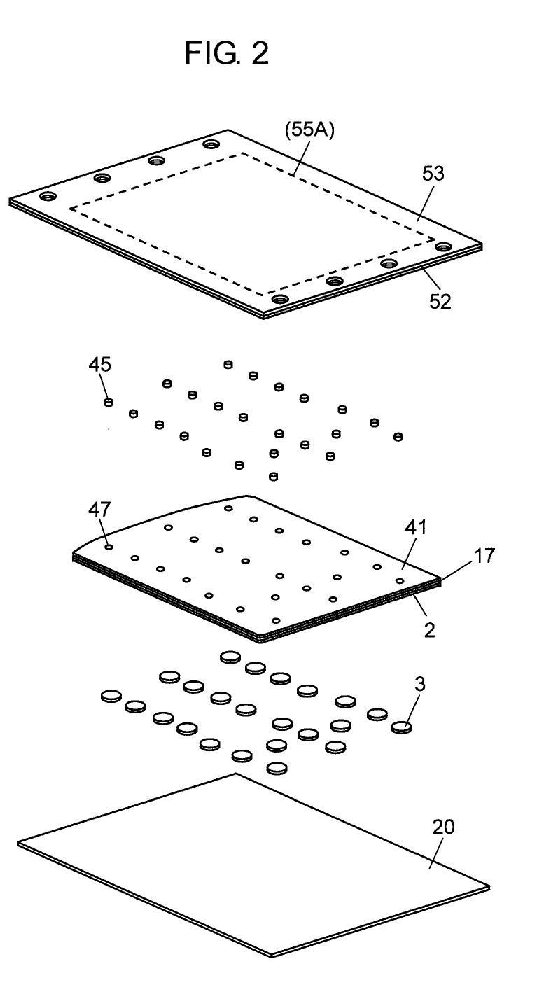

FIG. 1 is a sectioned view of a movable contact unit with bumps manufactured according to a method of manufacturing of the movable contact unit in this exemplary embodiment of the invention, and FIG. 2 is an exploded perspective view of the same movable contact unit.

In these figures, functional layer 17 constituting an EL element is overlaid on an underside surface of base film 41 of an optically transparent PET film, which is cut and formed into a predetermined outer shape. In addition, a number of movable contacts 3 are adhesively fixed individually to predetermined positions on an underside surface of functional layer 17 with adhesive layer 2. Bump members 45 also formed of a PET film into a cylindrical shape of small diameter by a punching process are bonded with adhesive 47 to base film 41 in locations corresponding to center positions of movable contacts 3, and the movable contact unit with bumps is thus composed.

Bump members 45 formed of the TPU film by the punching process and bonded here are cylindrical in shape and as small as 1.0 to 1.5 mm in diameter when movable contacts 3 have a diameter of 4 mm. Since the movable contact unit with bumps of this exemplary embodiment is manufactured by the method of the present invention, bump members 45 are formed without leaving a substantial extent of cutting burrs stated above, and bonded in the consistent manner without requiring selection of them.

The movable contact unit with bumps is manufactured in such a configuration that the upper side is covered with first reinforcing film 53, as shown in the drawings. However, the movable contact unit with bumps may be transported and stored in a configuration not provided with first reinforcing film 53, although details of first reinforcing film 53 will be described later. Besides, separator 20 having its upper surface treated with release lining is adhered to adhesive layer 2 from the underside thereof to protect movable contacts 3 and adhesive layer 2 from unwanted dust.

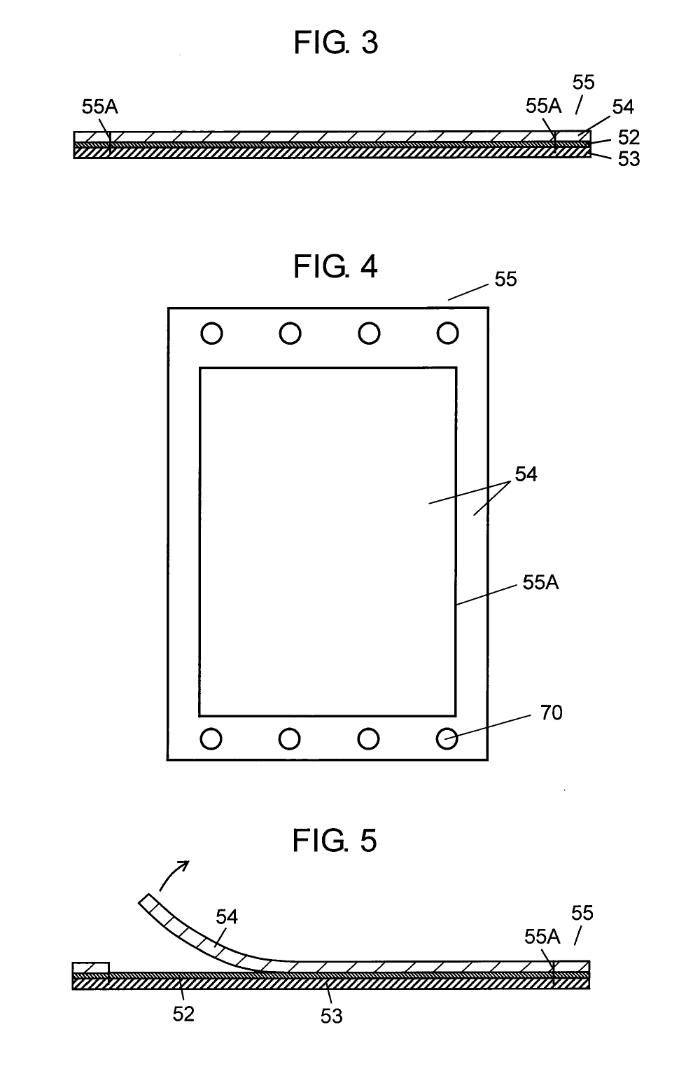

Referring now to FIG. 3 to FIG. 18, description is provided of the manufacturing method of this invention to obtain a movable contact unit with bumps of the structure discussed above.

### [First Step]

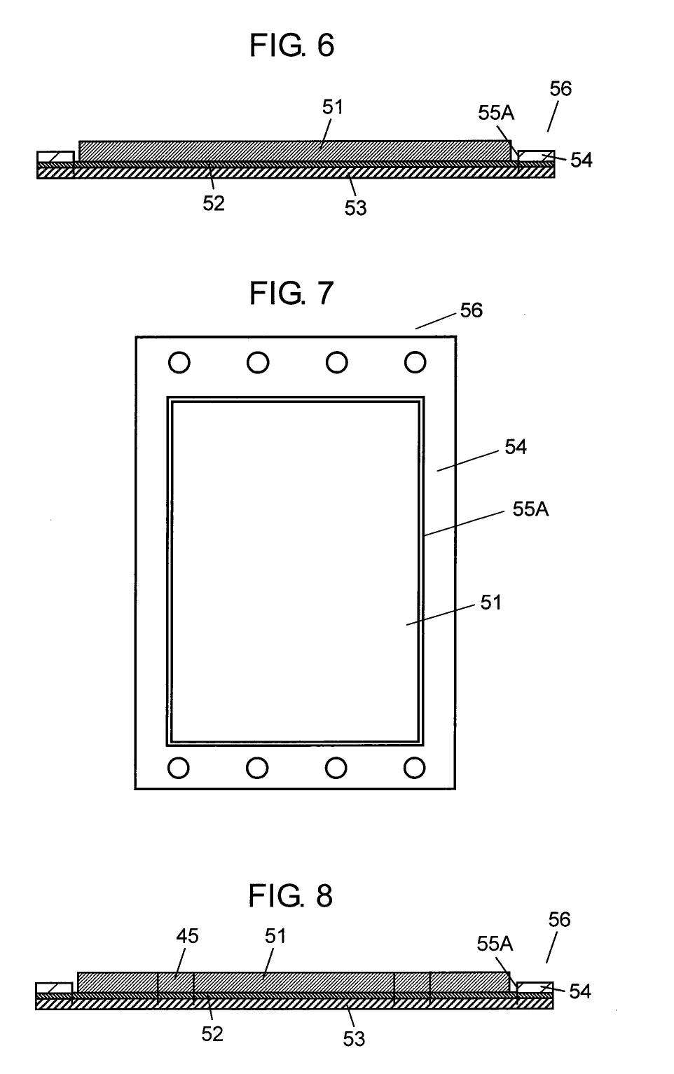

Prepared first is optically transparent first plastic film 51 (TPU film) having a high flexibility, as the first step of forming bump members 45 (refer to FIG. 6). Base member 55 shown in the sectioned view of FIG. 3 is prepared next by adhering first reinforcing film 53 (PET film) formed of a material having a higher rigidity than first plastic film 51 to supplementary film 54 (PET film) formed of a material having similarly a high rigidity with adhesive layer 52. In this instance, first plastic film 51 needs to have a thickness just equivalent to a required height (150 μm to 300 μm) of bump members 45. First reinforcing film 53 also needs to have a thickness appropriate for handling without any difficulty and suitable to undergo the half-cut process, as will be described later. It is desirable, for example, that first reinforcing film 53 is 50 μm or greater in the thickness when first plastic film 51 of the above material has a thickness of 150 μm to 300 μm.

Next, pilot holes 70 are perforated at both sides of base member 55 as shown in the sectioned view of FIG. 3 and the plan view of FIG. 4, and a half-cut process is carried out in a frame-like shape from the side of supplementary film 54 to cut out at least a part of supplementary film 54 by using these pilot holes 70 or other holes as the reference. A cut-out area inside frame 55A becomes a processing area where a plurality of bump members 45 are formed all at once.

Subsequently, the part of supplementary film 54 representing the processing area inside frame 55A is removed as shown in the sectioned view of FIG. 5 to expose adhesive layer 52 within the processing area. The aforesaid first plastic film 51 prepared first of a size equal to or slightly smaller than that of the processing area is adhered thereafter in the processing area with adhesive layer 52, as shown in the sectioned view of FIG. 6 and the plan view of FIG. 7, to make first substrate 56 (refer to FIG. 6). An area outside of frame 55A remains the original configuration of base member 55 having first reinforcing film 53 adhered to supplementary film 54, so that this area maintains the stiffness suitable for use as a grip in this and the subsequent processes, thereby helping the workability.

Afterwards, a half-cut process is carried out on first substrate 56 from above the first plastic film 51 to cut through both first plastic film 51 and adhesive layer 52 in the shape of bump members 45 by using pilot holes 70 and the like as the reference, as shown in the sectioned view of FIG. 8. This process completes formation of the plurality of bump members 45 of the small cylindrical shape all at once on the processing area inside frame 55A. The forming positions of bump members 45 are aligned with the corresponding locations of the movable contact unit where they are bonded. The work processed in this manner represents the first work-in-process item (refer to FIG. 8).

During the above half-cut process, bump members 45 can be formed easily into the proper shape while reducing the cutting burrs to a considerable extent from the lower side edges in the cutting direction since first plastic film 51 undergoes the cutting process in a state supported by first reinforcing film 53. In addition, individual bump members 45 can be kept adhered to first reinforcing film 53 with adhesive layer 52 as they are cut out from first plastic film 51 even after the cutting process. This enables the individual bump members 45 to be handled together with first reinforcing film 53 of high stiffness so as to eliminate the inconvenience of handling bump members 45 individually.

### [Second Step]

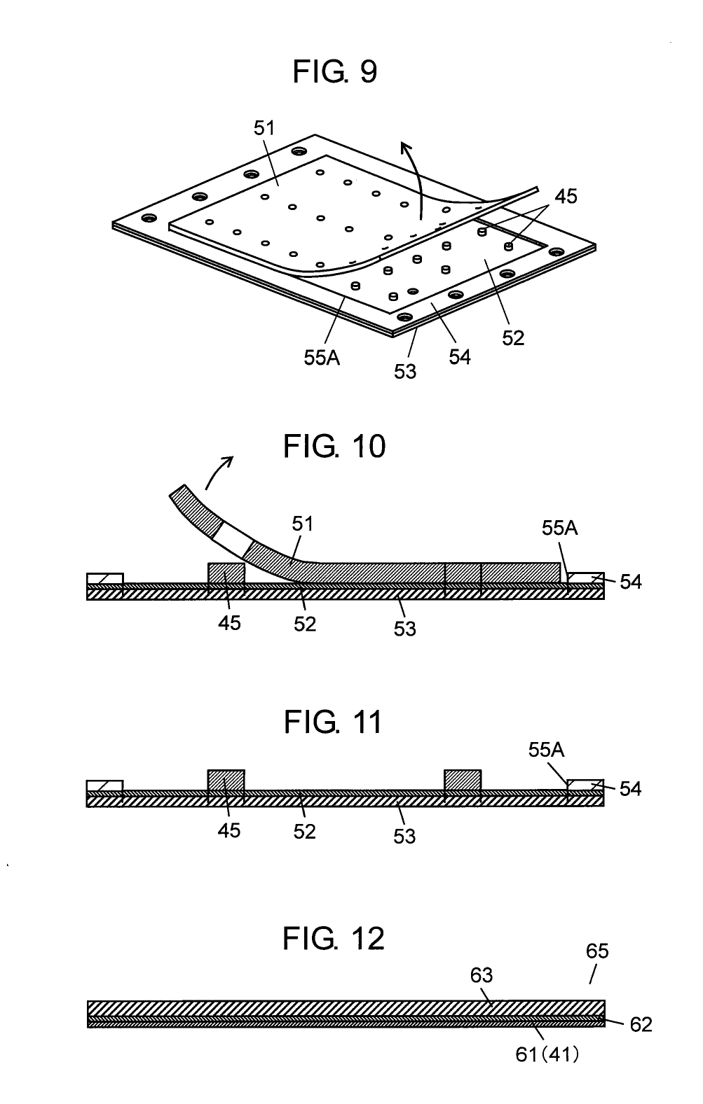

Next, an unnecessary portion of first plastic film 51 other than bump members 45 is removed from the first work-in-process item, as shown in the perspective view of FIG. 9 and the sectioned view of FIG. 10, to make a second work-in-process item, as the second step (also refer to FIG. 11). In other words, the second work-in-process item has the individual bump members 45 left intact as they are cut out and formed of first plastic film 51 and adhesive layer 52, and adhesive layer 52 is exposed in the area above first reinforcing film 53 where first plastic film 51 is removed, as shown in the sectioned view of FIG. 11. It is desirable to roughen the surface of first plastic film 51 whereon adhesive layer 52 is adhered in order to keep adhesive layer 52 remain on first reinforcing film 53 as stated above.

On the other hand, another part associated with the movable contact unit is processed in parallel with the first step and the second step. This process is described next as a third step.

### [Third Step]

In the third step, second substrate 65 is prepared first by adhering second plastic film 61 (TPU film) of high flexibility and second reinforcing film 63 of a material (PET film) having rigidity higher than that of second plastic film 61 using adhesive layer 62 as shown in the sectioned view of FIG. 12. It is desirable that second substrate 65 is formed beforehand into the same outer shape as the final product since second plastic film 61 serves as equivalent to base film 41 (refer to FIG. 1). Although second plastic film 61 is formed of a TPU film featuring an excellent flexibility, it is desirable for the TPU film to have a thickness of 150 μm or less, for instance, and it is especially more desirable to have a thickness as small as 50 μm or less. On the other hand, second reinforcing film 63 only needs to have a thickness sufficient to ease the handling as previously discussed and not causing any difficulty in a printing process as will be described later.

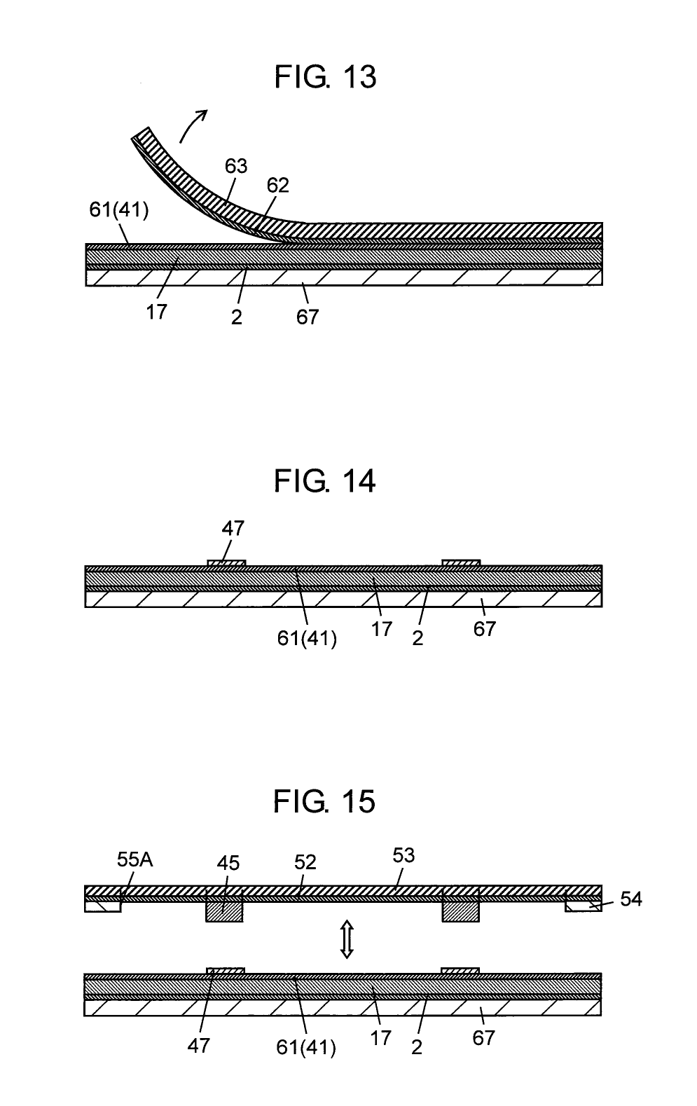

Next, functional layer 17 constituting the EL element is formed into a predetermined pattern on second substrate 65, as shown in the sectioned view of FIG. 13, by repeating printing and baking over second plastic film 61 in the same manner as that of the conventional art. After completing a printing process of forming adhesive layer 2 in a predetermined pattern on top of functional layer 17, temporary separator 67 is adhered to adhesive layer 2. Second reinforcing film 63 and adhesive layer 62 are then removed together to expose a surface, i.e., the one opposite the other surface bearing functional layer 17 of the EL element, of base film 41 composed of second plastic film 61. It is also possible to form the outer shape of second plastic film 61 by carrying out a half-cut process from the side facing second plastic film 61 toward second reinforcing film 63, and removing the unnecessary portion at the same time. In this case, the process of cutting the outer shape can be made while supporting second plastic film 61 with second reinforcing film 63, so as to reduce cutting burrs around the outer periphery.

Following the above, adhesive 47 for bonding the bump members is coated partially (in a dotted manner) on the exposed surface of second plastic film 61 corresponding to the positions of individual bump members 45, and this is named a third work-in-process item (refer to FIG. 14). It is important here to keep the exposed surface of second plastic film 61 free from residue and stain of the adhesive material. In other words, the exposed surface becomes the upside of the movable contact unit for adhesively fixing the individual bump members 45, as is obvious from what has been discussed above. It is for this reason that any dust and the like particles, if present on this surface, causes impedimental to the bonding secureness of adhesive 47. The surface exposed in the previous process is therefore cleansed with a prescribed chemical agent, and it is then coated with adhesive 47 in a dotted manner. This step can remove undesired dust and substances such as silicone if migrated or remained and even not visually recognizable on the exposed surface of second plastic film 61, thereby preventing deterioration of bonding strength of adhesive 47 after hardened.

### [Fourth Step]

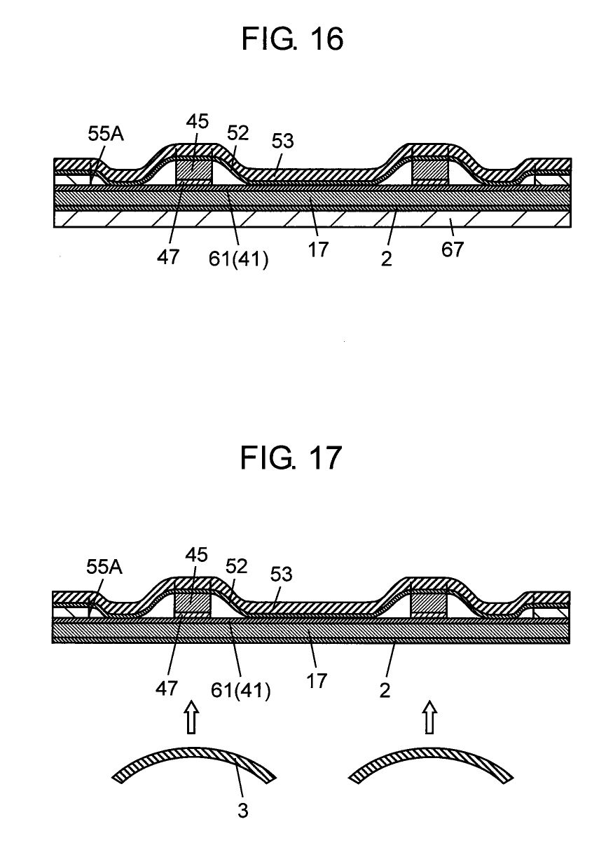

Subsequently, in the fourth step, the second work-in-process item shown in FIG. 11 and the third work-in-process items shown in FIG. 14 are put together to compose a fourth work-in-process item. That is, the second work-in-process item is positioned in alignment with the third work-in-process item in a manner so that bump members 45 are bonded on base film 41 consisting of second plastic film 61 with adhesive 47 on the third work-in-process item, as shown in the sectioned view of FIG. 15. The second work-in-process item is then bonded to the third work-in-process item with exposed adhesive layer 52 to complete a fourth work-in-process item shown in FIG. 16.

### [Fifth Step]

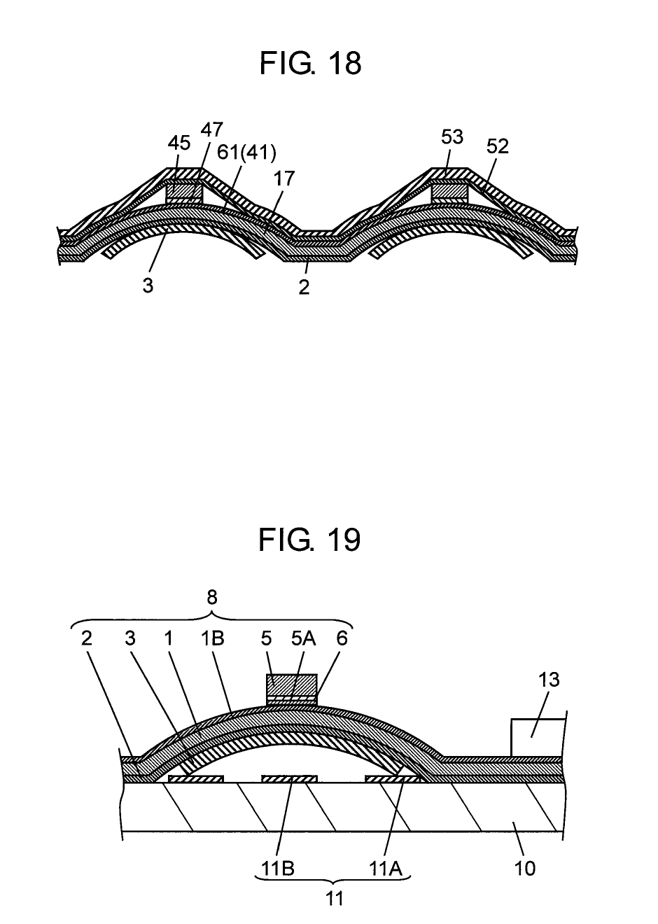

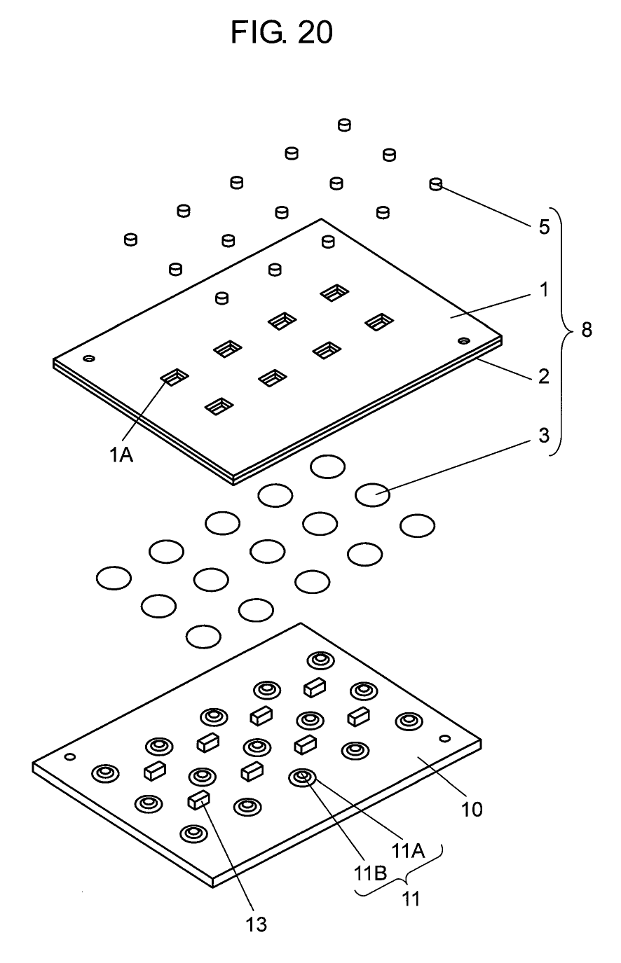

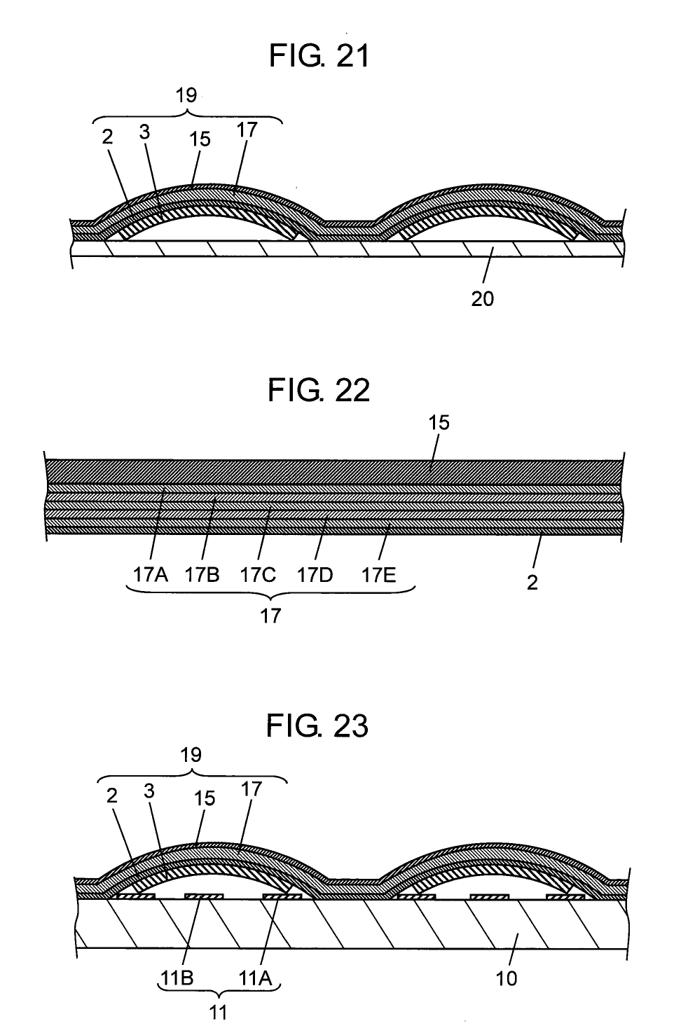

In the subsequent fifth step, adhesive 47 is hardened to securely bonding bump members 45 to base film 41, and temporary separator 67 adhered to one side facing functional layer 17 constituting the EL element is removed to expose adhesive layer 2 as shown in the sectioned view of FIG. 17. Following the above, movable contacts 3 are positioned in a manner to align vertically with mounted locations of their respective bump members 45, and adhesively bond movable contacts 3 to functional layer 17 of the EL element by means of exposed adhesive layer 2. This step can provide a movable contact unit with bumps of a structure, of which an upper surface is covered with first reinforcing film 53 as shown in the sectioned view of FIG. 18. Finally, the movable contact unit with bumps shown in FIG. 1 is completed by adhering separator 20 onto the backside of the movable contact unit for protection of movable contact 3 and adhesive layer 2.

Prior to assembling the movable contact unit with bumps of this exemplary embodiment into an apparatus, first reinforcing film 53 and separator 20 are removed, and the unit is bonded to a corresponding wiring board with adhesive layer 2 for use as a panel switch. In other words, this exemplary embodiment provides the panel switch constructed of the movable contact unit with bumps, which comprises bump members 45 formed of a highly flexible TPU film not carrying an appreciable extent of cutting burrs, and base film 41 also formed of a highly flexible TPU film, wherein the bump members 45 are bonded to base film 41. The panel switch can therefore provide little restrictions upon making alignment with control buttons at the apparatus side, outstanding bonding reliability of bump members 45 and excellent tactile responses over a long period of time.

According to the present invention, as described above, this manufacturing method realizes reduction of cutting burrs in the process of punching out bump members 45 even from a highly flexible TPU film having considerably small thickness. In addition, this method can facilitate the manufacturing processes while effectively using first reinforcing film 53 and the like members as production supporting materials. They can improve the handling ease of various work items and facilitate the continuous production of movable contact units with bumps of high quality. The invented method also provides an effect of reducing the manufacturing man-hours since this method allows bonding of many bump members 45 all at once on a movable contact unit.

When bump members 45 formed of a TPU film are to be bonded to base film 41 also of a TPU film, it is desirable that bump members 45 is made of an optically transparent material, both first reinforcing film 53 and adhesive layer 52 are also made of optically transparent materials, and adhesive 47 is of an UV-hardened type material made of urethane-acrylate resin. In other words, use of such a material for adhesive 47 can harmonize all the materials of adhesive 47, base film 41 and bump members 45 to be bonded into the same group of urethane resins. These materials improve compatibilities among their interfaces of adhesion, and they thereby increase strength of the adhesion between bump members 45 and base film 41, and shorten the hardening time of adhesive 47.

What has been described in this exemplary embodiment is an example, in which TPU films are used for both first plastic films 51 and second plastic films 61, but these components may also be made of materials of different types. Or, plastic films made of highly flexible materials may instead be used beside the TPU films. Furthermore, the manufacturing method of the present invention is also adaptable to other type of films having highly rigid properties such as PET if their thicknesses do not exceed 50 μm, for instance, though they are somewhat difficult to handle.

Although what has been described in this exemplary embodiment is a typical example of the movable contact unit having various functional layers 17 to compose the EL element, the present invention is also adaptable to any movable contact unit not provided with various functional layers 17. When this is the case, the second plastic film can be formed of a substrate of single material.

What is claimed is:

1. A method of manufacturing a movable contact unit with bumps, the method comprising:
a first step of forming a first work-in-process item by preparing a first substrate comprising a first plastic film having flexibility and a first reinforcing film of higher rigidity than the first plastic film, the first reinforcing film adhered to the underside of the first plastic film with an adhesive layer, and by carrying out a half-cut process on an upper side of the first substrate to cut through the first plastic film and the adhesive layer to form bump members of a given shape;
a second step of forming a second work-in-process item by removing an unnecessary portion of the first plastic film in a manner to leave the bump members formed by the half-cut process on the first reinforcing film and to expose the adhesive layer in an area where the portion of the first plastic film is removed;
a third step of forming a third work-in-process item by coating an adhesive for bonding the bump members on one of surfaces of a second plastic film having flexibility;
a fourth step of forming a fourth work-in-process item by positioning the second work-in-process item with the third work-in-process item in a manner to bond the bump members left on the second work-in-process item to the second plastic film with the adhesive on the third work-in-process item and bonding the second work-in-process item onto the third work-in-process item by using the adhesive layer exposed on the second work-in-process item; and
a fifth step of fixing movable contacts to an opposite surface of the second plastic film in locations corresponding to positions where the bump members are bonded, after completing hardening of the adhesive.

2. The method of manufacturing movable contact unit with bumps as recited in claim 1, wherein the third step of forming the third work-in-process item includes processes of
forming a functional layer constituting an electroluminescent element on the second plastic film by using a second substrate provided with a second reinforcing film adhered on one of the surfaces of the second plastic film, the second reinforcing film formed of a material having higher rigidity than the second plastic film;
removing the second reinforcing film off the second plastic film;
cleansing an exposed surface of the second plastic film; and
coating the surface of the second plastic film partially with the adhesive for bonding the bump members.
